(19) United States
(12) Patent Application Publication
(10) Pub. No.: US 2003/0025825 A1
(43) Pub. Date: Feb. 6, 2003

(54) Small image pickup module

(75) Inventor: Yasuo Nakajoh, Niiza-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Optical Co., Ltd., Tokyo (JP)

(21) Appl. No.: 10/231,244

(22) Filed: Aug. 29, 2002

Related U.S. Application Data
(63) Continuation of application No. PCT/JP01/01228, filed on Feb. 21, 2001.

(30) Foreign Application Priority Data
Mar. 2, 2000 (JP) 2000-057283

(51) Int. Cl. H04N 5/225

(52) U.S. Cl. 348/374; 348/340

(57) ABSTRACT

A substrate is made from a nonmetal including a ceramic or the like. A semiconductor device chip for image pickup includes a two-dimensional C-MOS image sensor or the like which is mounted on the substrate. A lens-barrel body is attached to the substrate so as to enclose the semiconductor device chip for image pickup therein. The infrared light blocking filter, lens, and diaphragm are respectively mounted on the lens-barrel body. A transparent member is provided between the substrate and the lens-barrel body so as to protect a surface portion of the semiconductor device chip for image pickup. A potting material is provided so as to cover an electrode lead or the like at a peripheral portion of the semiconductor device chip for image pickup and so as to simultaneously adhere a peripheral portion of the transparent member.

### CROSS REFERENCE TO RELATED APPLICATIONS

This is a Continuation Application of PCT Application No. PCT/JP01/01228, filed Feb. 21, 2001, which was not published under PCT Article 21(2) in English.

This application is based upon and claims the benefit of priority from the prior Japanese Patent Application No. 2000-057283, filed Mar. 2, 2000, the entire contents of which are incorporated herein by reference.

### BACKGROUND OF THE INVENTION

1. Field of the Invention

The present invention relates to a small image pickup module, and in particular, to a small image pickup module in which a lens and a semiconductor device chip for image pickup are accommodated in one package and integrated.

2. Description of the Related Art

In recent years, the demand for small image sensor units has increased in fields of various types and various kinds of multimedia such as note-type personal computers, mobile phones and the like, and further, for image inputting equipment of information terminals such as monitoring cameras, video tape recorders and the like, and for in-vehicle applications or the like.

As a small image sensor unit suitable for this type of image inputting equipment, there is an image pickup module in which parts such as a solid-state image pickup device, a lens member, a filter, a diaphragm member and the like are accommodated in one package and integrated.

The image pickup module as a conventional image sensor unit has a structure in which, after a solid-state image pickup device is mounted on a substrate, the substrate is fixed in a package by screwing, adhesion or the like, and a supporting frame holding a lens member is mounted on the above-described package.

Since the image pickup module has a structure as described above, the accuracy of the positional relationship of the lens with respect to the solid-state image pickup device cannot be sufficiently ensured.

In this way, the accuracy of positioning of the lens with respect to the solid-state image pickup device is inferior in the image pickup module as a conventional image sensor unit. Therefore, a movable type focal point adjusting mechanism carrying out focusing is built into the package, each part is assembled at the package, and then focusing of the lens member with respect to the solid-state image pickup device is carried out by the focal point adjusting mechanism.

However, in accordance therewith, the work of focusing in which the movable type adjusting mechanism is operated after each part is assembled is necessary. Further, after the focus adjustment, the work of fixing a lens-barrel member or the like is necessary.

If the movable type focus adjusting mechanism is provided, there are the trends that the structure becomes complicated, and the image pickup module as the image sensor unit becomes large.

Further, during the work of focusing, dust easily enters the unit from gaps of the movable portion of the focus adjusting mechanism, and a countermeasure therefor is necessary. For example, there is the need for the work of focus adjustment to be carried out in a clean room or the like, and productivity is inferior.

Moreover, if the movable focus adjusting mechanism receives vibration, shock or the like after completion of the product, there are the drawbacks that the focusing position is easily distorted and the reliability of the product is inferior.

Accordingly, a solid-state image pickup apparatus structured such that the positioning accuracy, in the optical axis direction, of a lens with respect to a solid-state image pickup device can be easily ensured is proposed in Jpn. Pat. Appin. KOKAI Publication No. 9-232548.

The solid-state image pickup apparatus disclosed in the Jpn. Pat. Appln. KOKAI Publication is configured such that a plurality of positioning portions are formed in step-shapes at a single supporting member, and parts such as a solid-state image pickup device, a lens member, a filter, a diaphragm member and the like are separately and individually attached to the individual positioning portions, thereby the respective members are positioned and fixed.

However, in such solid-state image pickup apparatus, because the plurality of positioning portions are formed in step-shapes at the single supporting member, dimension errors between the respective steps directly and greatly affect the positioning accuracy of the respective members.

Moreover, in order to form the plurality of positioning portions in step-shapes at the single supporting member, management of the accuracy of the dimensions is difficult and errors occur easily. A high-level manufacturing technology is required to form the plurality of positioning portions in step-shapes at the one supporting member.

In particular, when the single supporting member is made from a ceramic, manufacture thereof is extremely difficult, and the product is expensive.

Here, it is mainly considered to manufacture the supporting member by injection molding by using synthetic resin or the like as the raw material.

However, even if the supporting member is made by injection molding, it is thought that it is easy for the dimensional errors between the respective positioning portions which are stepped to be large, and that the errors also increase due to changes over time thereafter, and reliability of the product is inferior.

Further, in Japanese Patent No. 2559986, a prior art is disclosed in which the substrate as described above is mounted by utilizing a spring effect using a side wall of an enclosure as a supporting member such as that described above.

However, in the prior art in accordance with Japanese Patent No. 2559986, there is the problem that joggling based on the creep phenomenon over time occurs.

Further, in Jpn. Pat. Appln. KOKOKU Publication No. 8-28435, a prior art relating to improvement of an adhesive structure of a metal can and a lens molten glass is disclosed. However, in the case of this structure, there is the need to consider the wetting characteristic of the molten glass.

Further, in Jpn. Pat. Appin. KOKAI Publication No. 10-41492, a prior art is disclosed in which a lens cap and a pedestal are positioned by a guide pin and fixed.

However, in the case of this structure, there are the problems that the lens cap and the guide pin are necessary, the structure is complicated, productivity is poor, and the manufacturing costs increase.

Further, in Jpn. Pat. Appln. KOKAI Publication No. 5-136384, an image pickup module is disclosed which comprises: a chip carrier on which a required terminal and circuit pattern are provided; a solid-state image pickup device loaded/disposed at a predetermined region thereof; a bonding wire electrically connecting between the terminal of the solid-state image pickup device and the terminal of the chip carrier; a filter glass plate and a transparent protecting plate integrally provided on a surface of a light receiving portion of the solid-state image pickup device via a transparent silicone layer; and a colored silicone molded layer covering and mechanically and environment-resistantly protecting a side surface portion of the solid-state image pickup device and the bonding wire portion.

However, in the case of the structure of such an image pickup module, the filter glass plate and the transparent protecting plate are integrally disposed via the transparent silicone layer on the surface of the light receiving portion of the solid-state image pickup device. Therefore, there is no space on the surface of the light receiving portion of the solid-state image pickup device, and it was difficult to provide a microlens for making an aperture large and increasing the efficiency of the incident light on the surface.

Namely, in the conventional solid-state image pickup apparatus as described above, there were the problems that errors, in the dimensions between the steps between the respective positioning portions, occur easily, and it is difficult to manage the dimensions, and the positioning accuracy, in the optical axis direction, of the lens with respect to the solid-state image pickup device cannot be sufficiently ensured.

Further, in the conventional solid-state image pickup apparatus as described above, the structure is complicated, the productivity is poor, the manufacturing costs increase, and it is an expensive product.

Further, in the conventional solid-state image pickup apparatus, it was difficult to dispose the microlens for making the aperture large and increasing the efficiency of the incident light, on the surface of the light receiving portion of the solid-state image pickup device.

### BRIEF SUMMARY OF THE INVENTION

An object of the present invention is to provide a small image pickup module which has been achieved in consideration of the circumstances, and in which, in a structure in which a semiconductor device chip for image pickup including a two-dimensional C-MOS image sensor or the like is mounted on a nonmetal substrate including a ceramic or the like and a lens-barrel body is mounted so as to cover it, the assembly work is easy and a reduction in costs is possible due to the mounting structure being variously improved.

Further, another object of the present invention is to provide a small image pickup module which has been achieved in consideration of the circumstances, and in which, in a structure in which a semiconductor device chip for image pickup including a two-dimensional C-MOS image sensor or the like is mounted on a nonmetal substrate including a ceramic or the like and a lens-barrel body is mounted so as to cover it, the assembly work is easy and a reduction in costs is possible due to the mounting structure being variously improved, and further, it is possible to dispose a microlens for making an aperture large and increasing the efficiency of the incident light, on a surface of a light receiving portion of the semiconductor device chip for image pickup.

In order to achieve the above object, according to the present invention, there is provided,

(1) a small image pickup module comprising:

a substrate made from a nonmetal including a ceramic or the like;

a semiconductor device chip for image pickup including a two-dimensional C-MOS image sensor or the like which is mounted on the substrate;

a lens-barrel body which is attached to the substrate so as to enclose the semiconductor device chip for image pickup therein;

an infrared light blocking filter, a lens, and a diaphragm which are respectively mounted on the lens-barrel body;

a transparent member which is provided between the substrate and the lens-barrel body so as to isolate and protect a surface portion of the semiconductor device chip for image pickup; and

a potting material which is provided so as to cover an electrode lead or the like at a peripheral portion of the semiconductor device chip for image pickup and so as to simultaneously adhere a peripheral portion of the transparent member.

In order to achieve the above object, according to the present invention, there is provided,

(2) a small image pickup module recited in item (1) above, wherein a potting material to be used for COB (Chip On Board) mounting is used as an adhesive adhering the lens-barrel body to the substrate.

In order to achieve the above object, according to the present invention, there is provided,

(3) a small image pickup module recited in item (1) above, wherein, as a mounting structure which mounts the lens-barrel body on the substrate, projections for positioning are provided at a bottom portion of the lens-barrel body, and fitting holes, in which the projections for positioning provided at the bottom portion of the lens-barrel body are fitted, are provided at opposing positions on the substrate.

In order to achieve the above object, according to the present invention, there is provided,

(4) a small image pickup module recited in item (1) above, wherein bare chips of various ICs are mounted on the substrate.

In order to achieve the above object, according to the present invention, there is provided,

(5) a small image pickup module recited in item (1) above, wherein a flexible substrate for external connection is mounted on the substrate, and a light-blocking pattern which blocks light from a direction of a bottom portion of the substrate is formed on the flexible substrate.

In order to achieve the above object, according to the present invention, there is provided,

(6) a small image pickup module recited in item (1) above, wherein a land-and-through-hole portion for external connection is provided at the substrate, and electric connection and mechanical holding with another substrate are made possible due to another substrate being engaged at the land-and-through-hole portion.

In order to achieve the above object, according to the present invention, there is provided,

(7) a small image pickup module recited in any one of items (1) to (6) above, wherein a microlens is provided at a front surface of the semiconductor device chip for image pickup.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a cross-sectional view showing a basic structure as a small image pickup module according to the present invention.

FIG. 2 is a cross-sectional view showing a schematic structure of a small image pickup module according to a first embodiment of the present invention.

FIG. 3 is a cross-sectional view showing a schematic structure of a small image pickup module according to a second embodiment of the present invention.

FIG. 4 is a cross-sectional view showing a schematic structure of a small image pickup module according to a third embodiment of the present invention.

FIG. 5 is a cross-sectional view showing a schematic structure of a small image pickup module according to a fourth embodiment of the present invention.

FIG. 6A and FIG. 6B are a cross-sectional view and a rear view showing a schematic structure of a small image pickup module according to a fifth embodiment of the present invention.

FIG. 7 is a cross-sectional view showing a schematic structure of a small image pickup module according to a sixth embodiment of the present invention.

FIG. 8 is a cross-sectional view of a main portion of a schematic structure in a case in which a microlens applied to a small image pickup module according to first to sixth embodiments of the present invention is mounted.

### DETAILED DESCRIPTION OF THE INVENTION

Hereinafter, respective embodiments of the present invention will be described by using the figures.

(Basic Structure)

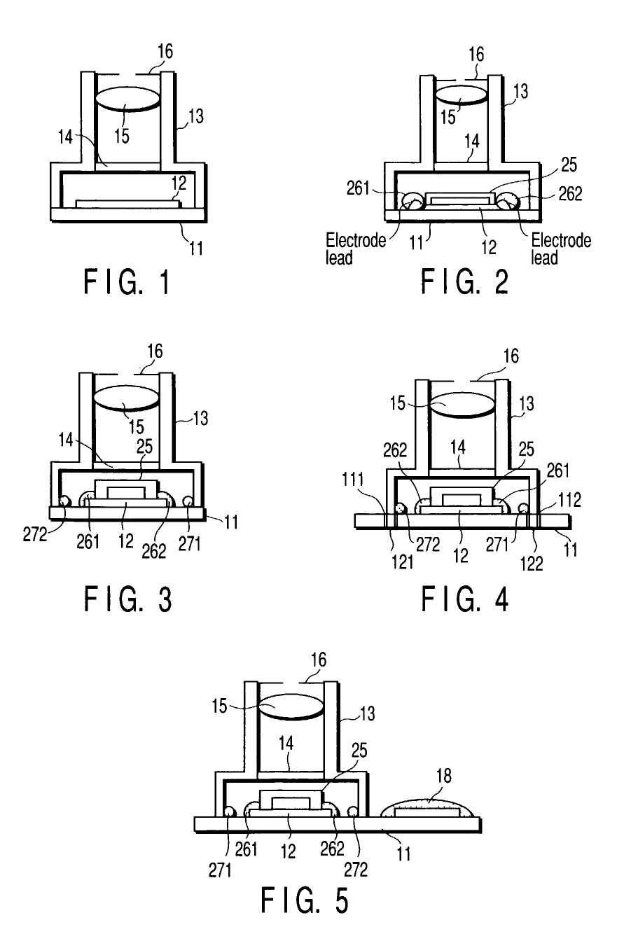

FIG. 1 is a cross-sectional view showing a basic structure as a small image pickup module according to the present invention.

Namely, as shown in FIG. 1, the small image pickup module according to the present invention is, as the basic structure, structured from a rectangular-shaped substrate 11 made from a nonmetal including a ceramic or the like, a semiconductor device chip 12 for image pickup including a two-dimensional C-MOS image sensor or the like which is mounted on the nonmetal substrate 11, a lens-barrel body 13 which has a hollow structure such as a rectangular cylinder shape or the like and which is attached as a reference to the nonmetal substrate 11 so as to cover the semiconductor device chip 12 for image pickup, and an infrared light (IR) blocking filter 14, a lens 15, and a diaphragm 16 which are respectively mounted on the lens-barrel body 13.

Here, it is assumed that, there is provided at the semiconductor device chip 12 for image pickup, for example, a semiconductor circuit section or the like, in which a photoelectric converting section (sensor section) formed from a group of photoelectric converting elements forming the two-dimensional C-MOS image sensor and arrayed two-dimensionally; a driving circuit section for driving the group of photoelectric converting elements successively and obtaining signal electric charges; an analog-to-digital converting section for converting the signal electric charges to a digital signal; a signal processing section for making the digital signal an image signal output; and exposure controlling means for electrically controlling the exposing time on the basis of an output level of the digital signal are formed on the same semiconductor chip.

Further, the nonmetal substrate 11 holds the semiconductor chip, and an electrode group electrically connected to the semiconductor chip is formed.

The nonmetal substrate 11 is, for example, a hard bulk type ceramic substrate, and the above semiconductor chip is adhered to and loaded on the top surface thereof.

In this case, the nonmetal substrate 11 made from ceramic is a plate-shaped structure having a rectangular shape and a uniform thickness in which a raw material of an integral bulk material is calcinated, and the top surface thereof is formed so as to uniformly be the same flat surface.

The small image pickup module thus structured according to the basic structure of the present invention operates such that, for example, a digital or analog image signal is output by image-forming a photographed object image on the sensor section at the semiconductor device chip 12 for image pickup on the nonmetal substrate 11 via the diaphragm section 16, the lens 15, and the infrared light (IR) blocking filter 14, and by photoelectrically converting the image.

In the small image pickup module according to the basic structure of the present invention structured as described above, a package in which a two-dimensional sensor according to prior art is independently housed can be omitted. A reduction in cost and an improvement in mounting performance can be attempted while improving the optical performance.

(First Embodiment)

FIG. 2 is a cross-sectional view showing a schematic structure of a small image pickup module according to a first embodiment of the present invention.

Namely, as shown in FIG. 2, the small image pickup module according to the first embodiment of the present invention comprises, as the basic structure: the substrate 11 made from a nonmetal including a ceramic or the like; the semiconductor device chip 12 for image pickup including a two-dimensional C-MOS image sensor or the like which is mounted on the nonmetal substrate 11; the lens-barrel body 13 which is attached as a reference to the nonmetal substrate 11 so as to cover the semiconductor device chip 12 for image pickup; and the infrared light (IR) blocking filter 14, the lens 15, and the diaphragm 16 which are respectively mounted on the lens-barrel body 13, as shown in FIG. 1.

In the basic structure of the small image pickup module structured in this way, the small image pickup module according to the first embodiment of the present invention is characterized by further comprising: a transparent member 25 which is provided between the nonmetal substrate 11 and the lens-barrel body 13 so as to isolate and protect a surface portion of the semiconductor device chip 12 for image pickup; and potting materials 261, 262 provided so as to cover the wire bonding or the like to an electrode lead at the peripheral portion of the semiconductor device chip 12 for image pickup and so as to simultaneously adhere the peripheral portion of the transparent portion 25 while avoiding a sensor portion of the semiconductor device chip 12 for image pickup.

FIG. 8 is a cross-sectional view of a main portion of a schematic structure in a case where a microlens, which is applied to respective small image pickup modules according to the first embodiment as described above and second to sixth embodiments to be described later of the present invention, is mounted.

In the small image pickup module according to the first embodiment of the present invention structured as described above, a package in which a two-dimensional sensor according to prior art is independently housed can be omitted. A reduction in cost and an improvement in mounting performance can be attempted while improving the optical performance.

Namely, in the small image pickup module according to the first embodiment of the present invention, the transparent member 25 is provided so as to isolate and protect the surface portion of the semiconductor device chip 12 for image pickup. Further the sensor portion and the wire bonding portion are completely shielded from outside air while being Chip-On-Board (COB) mounted by the potting materials 261, 262 provided so as to cover the wire bonding to an electrode lead at the peripheral portion of the semiconductor device chip 12 for image pickup and so as to simultaneously adhere the transparent portion 25. Therefore, it is possible to completely prevent the sensor portion and the wire bonding portion from being damaged or a silicon surface of the sensor portion from oxidizing at the time of mounting and outer mounting assembly, and the wire bonding portion can be completely covered. Accordingly, handling in the same way as a COB mounted general IC is possible, and it is possible to reduce the size and reduce costs.

Further, the transparent member 25 is disposed so as to be isolated from the surface of the sensor, and thereby effects of the microlens at the surface of the sensor do not deteriorate and it is possible to reduce the size.

Namely, as shown in FIG. 8, when microlenses 30 are respectively mounted via color filters 32 with respect to the front surfaces of respective image pickup devices 31 at the semiconductor device chip 12 for image pickup mounted on the nonmetal substrate 11, the transparent member 25 is disposed so as to be isolated from the surface of the sensor, and thereby effects of the respective microlenses 30 at the surface of the sensor do not deteriorate, and it is possible to reduce the size.

(Second Embodiment)

FIG. 3 is a cross-sectional view showing a schematic structure of a small image pickup module according to a second embodiment of the present invention.

Namely, as shown in FIG. 3, the small image pickup module according to the second embodiment of the present invention comprises, as the basic structure: the substrate 11 made from a nonmetal including a ceramic or the like; the semiconductor device chip 12 for image pickup including a two-dimensional C-MOS image sensor or the like which is mounted on the nonmetal substrate 11; the lens-barrel body 13 which is attached as a reference to the nonmetal substrate 11 so as to cover the semiconductor device chip 12 for image pickup; and the infrared light (IR) blocking filter 14, the lens 15, and the diaphragm 16 which are respectively mounted on the lens-barrel body 13, as shown in FIG. 1.

In the basic structure of the small image pickup module structured in this way, the small image pickup module according to the second embodiment of the present invention is characterized by further comprising: a transparent member 25 which is provided between the nonmetal substrate 11 and the lens-barrel body 13 so as to isolate and protect a surface portion of the semiconductor device chip 12 for image pickup; and potting materials 261, 262 provided so as to cover the wire bonding or the like to an electrode lead at the peripheral portion of the semiconductor device chip 12 for image pickup and so as to simultaneously adhere the peripheral portion of the transparent portion 25 while avoiding a sensor portion of the semiconductor device chip 12 for image pickup, and characterized in that the potting materials 271, 272 to be used for COB (Chip-On-Board) mounting are used as the adhesive adhering the lens-barrel body 13 to the nonmetal substrate 11.

In the small image pickup module according to the second embodiment of the present invention structured as described above, a package in which a two-dimensional sensor according to a prior art is independently housed can be omitted. A reduction in cost and an improvement in mounting performance can be attempted while improving the optical performance.

Namely, in the small image pickup module according to the second embodiment of the present invention, the transparent member 25 is provided so as to isolate and protect the surface portion of the semiconductor device chip 12 for image pickup. Further the sensor portion and the wire bonding portion are completely shielded from outside air while being Chip-On-Board (COB) mounted by the potting materials 261, 262 provided so as to cover the wire bonding to an electrode lead at the peripheral portion of the semiconductor device chip 12 for image pickup and so as to simultaneously adhere the transparent portion 25. Therefore, it is possible to completely prevent the sensor portion and the wire bonding portion from being damaged or a silicon surface of the sensor portion from oxidizing at the time of mounting and outer mounting assembly, and the wire bonding portion can be completely covered. Accordingly, handling in the same way as a COB mounted general IC is possible, and it is possible to reduce the size and reduce costs.

Further, the transparent member 25 is disposed so as to be isolated from the surface of the sensor, and thereby effects of the microlens at the surface of the sensor do not deteriorate and it is possible to reduce the size.

Namely, as shown in FIG. 8, when microlenses 30 are respectively mounted via color filters 32 with respect to the front surfaces of respective image pickup devices 31 at the semiconductor device chip 12 for image pickup mounted on the nonmetal substrate 11, the transparent member 25 is disposed so as to be isolated from the surface of the sensor, and thereby effects of the respective microlenses 30 at the surface of the sensor do not deteriorate, and it is possible to reduce the size.

In addition, a material different from the potting material used to be for Chip On Board (COB) mounting is used for adhesion of the lens-barrel body at the two-dimensional sensor in accordance with prior art. Therefore, there is a problem such as the generation of rust or the like with respect to the sensor at the interior, and problems in durability and assembly working performance remain. However, in the small image pickup module according to the second embodiment of the present invention, because the potting materials 271, 272 to be used for Chip-On-Board (COB) mounting are used as the adhesive adhering the lens-barrel body 13 to the nonmetal substrate 11. Therefore, there is no problem such as the generation of rust or the like with respect to the sensor at the interior, and it is possible to contribute to an improvement in durability and assembly working performance.

In this case, the potting materials 271, 272 have the function of being commonly used as filler and adhesive.

(Third Embodiment)

FIG. 4 is a cross-sectional view showing a schematic structure of a small image pickup module according to a third embodiment of the present invention.

Namely, as shown in FIG. 4, the small image pickup module according to the third embodiment of the present invention comprises, as the basic structure: the substrate 11 made from a nonmetal including a ceramic or the like; the semiconductor device chip 12 for image pickup including a two-dimensional C-MOS image sensor or the like which is mounted on the nonmetal substrate 11; the lens-barrel body 13 which is attached as a reference to the nonmetal substrate 11 so as to cover the semiconductor device chip 12 for image pickup; and the infrared light (IR) blocking filter 14, the lens 15, and the diaphragm 16 which are respectively mounted on the lens-barrel body 13, as shown in FIG. 1.

In the basic structure of the small image pickup module structured in this way, the small image pickup module according to the third embodiment of the present invention is characterized by further comprising: a transparent member 25 which is provided between the nonmetal substrate 11 and the lens-barrel body 13 so as to isolate and protect a surface portion of the semiconductor device chip 12 for image pickup; and potting materials 261, 262 provided so as to cover the wire bonding or the like to an electrode lead at the peripheral portion of the semiconductor device chip 12 for image pickup and so as to simultaneously adhere the peripheral portion of the transparent portion 25 while avoiding a sensor portion of the semiconductor device chip, and characterized in that, as a mounting structure for mounting the lens-barrel body 13 on the nonmetal substrate 11, projections 121, 122 for positioning are provided at the bottom portion of the lens-barrel body 13, and fitting holes 111, 112, in which the projections 121, 122 for positioning provided at the bottom portion of the lens-barrel body are fitted, are provided at opposing positions on the nonmetal substrate 11.

In the small image pickup module according to the third embodiment of the present invention structured as described above, a package in which a two-dimensional sensor according to prior art is independently housed can be omitted. A reduction in cost and an improvement in mounting performance can be attempted while improving the optical performance.

Namely, in the small image pickup module according to the third embodiment of the present invention, the transparent member 25 is provided so as to isolate and protect the surface portion of the semiconductor device chip 12 for image pickup. Further the sensor portion and the wire bonding portion are completely shielded from outside air while being Chip-On-Board (COB) mounted by the potting materials 261, 262 provided so as to cover the wire bonding to an electrode lead at the peripheral portion of the semiconductor device chip 12 for image pickup and so as to simultaneously adhere the transparent portion 25. Therefore, it is possible to completely prevent the sensor portion and the wire bonding portion from being damaged or a silicon surface of the sensor portion from oxidizing at the time of mounting and outer mounting assembly, and the wire bonding portion can be completely covered. Accordingly, handling in the same way as a COB mounted general IC is possible, and it is possible to reduce the size and reduce costs.

Further, the transparent member 25 is disposed so as to be isolated from the surface of the sensor, and thereby effects of the microlens at the surface of the sensor do not deteriorate and it is possible to reduce the size.

Namely, as shown in FIG. 8, when microlenses 30 are respectively mounted via color filters 32 with respect to the front surfaces of respective image pickup devices 31 at the semiconductor device chip 12 for image pickup mounted to the nonmetal substrate 11, the transparent member 25 is disposed so as to be isolated from the surface of the sensor, and thereby effects of the respective microlenses 30 at the surface of the sensor do not deteriorate, and it is possible to reduce the size.

In addition, the holes for positioning of the lens-barrel body at the two-dimensional sensor in accordance with prior art are such that the holes are not simply open at the substrate, but the shape of the substrate is formed in three dimensions to always match the lens-barrel body. This is a cause for the costs to remarkably increase.

In contrast, in the small image pickup module according to the third embodiment of the present invention, since the substrate 11 is plate-shaped as is, it is extremely inexpensive and assembly also is easy.

(Fourth Embodiment)

FIG. 5 is a cross-sectional view showing a schematic structure of a small image pickup module according to a fourth embodiment of the present invention.

Namely, as shown in FIG. 5, the small image pickup module according to the fourth embodiment of the present invention comprises, as the basic structure: the substrate 11 made from a nonmetal including a ceramic or the like; the semiconductor device chip 12 for image pickup including a two-dimensional C-MOS image sensor or the like which is mounted on the nonmetal substrate 11; the lens-barrel body 13 which is attached as a reference to the nonmetal substrate 11 so as to cover the semiconductor device chip 12 for image pickup; and the infrared light (IR) blocking filter 14, the lens 15, and the diaphragm 16 which are respectively mounted on the lens-barrel body 13, as shown in FIG. 1.

In the basic structure of the small image pickup module structured in this way, the small image pickup module according to the fourth embodiment of the present invention is characterized by further comprising: a transparent member 25 which is provided between the nonmetal substrate 11 and the lens-barrel body 13 so as to isolate and protect a surface portion of the semiconductor device chip 12 for image pickup; and potting materials 261, 262 provided so as to cover the wire bonding or the like to an electrode lead at the peripheral portion of the semiconductor device chip 12 for image pickup and so as to simultaneously adhere the peripheral portion of the transparent portion 25 while avoiding a sensor portion of the semiconductor device chip, and characterized in that bare chips 18 of various ICs are mounted on the outer side portion of the lens-barrel body 13 on the nonmetal substrate 11.

In the small image pickup module according to the fourth embodiment of the present invention structured as described above, a package in which a two-dimensional sensor according to a prior art is independently housed can be omitted. A reduction in cost and an improvement in mounting performance can be attempted while improving the optical performance.

Namely, in the small image pickup module according to the fourth embodiment of the present invention, the transparent member 25 is provided so as to isolate and protect the surface portion of the semiconductor device chip 12 for image pickup. Further the sensor portion and the wire bonding portion are completely shielded from outside air while being Chip-On-Board (COB) mounted by the potting materials 261, 262 provided so as to cover the wire bonding to an electrode lead at the peripheral portion of the semiconductor device chip 12 for image pickup and so as to simultaneously adhere the transparent portion 25. Therefore, it is possible to completely prevent the sensor portion and the wire bonding portion from being damaged or a silicon surface of the sensor portion from oxidizing at the time of mounting and outer mounting assembly, and the wire bonding portion can be completely covered. Accordingly, handling in the same way as a COB mounted general IC is possible, and it is possible to reduce the size and reduce costs.

Further, the transparent member 25 is disposed so as to be isolated from the surface of the sensor, and thereby effects of the microlens at the surface of the sensor do not deteriorate and it is possible to reduce the size.

Namely, as shown in FIG. 8, when microlenses 30 are respectively mounted via color filters 32 with respect to the front surfaces of respective image pickup devices 31 at the semiconductor device chip 12 for image pickup mounted on the nonmetal substrate 11, the transparent member 25 is disposed so as to be isolated from the surface of the sensor, and thereby effects of the respective microlenses 30 at the surface of the sensor do not deteriorate, and it is possible to reduce the size.

In addition, in the two-dimensional sensor in accordance with prior art, the substrate for mounting a sensor and other bare chips are not integrally structured, but are always structured so as to be separated into two or more substrates. Therefore, cables and connectors for connecting between the respective substrates are needed. Thus, this is a hindrance to prevention of noise generation and a reduction in costs. However, in the small image pickup module according to the fourth embodiment of the present invention, by mounting the bare chips 18 of various ICs on the outer side portion or the like of the lens-barrel body 13 on the substrate 11, all of the deficiencies in accordance with the prior art can be solved.

(Fifth Embodiment)

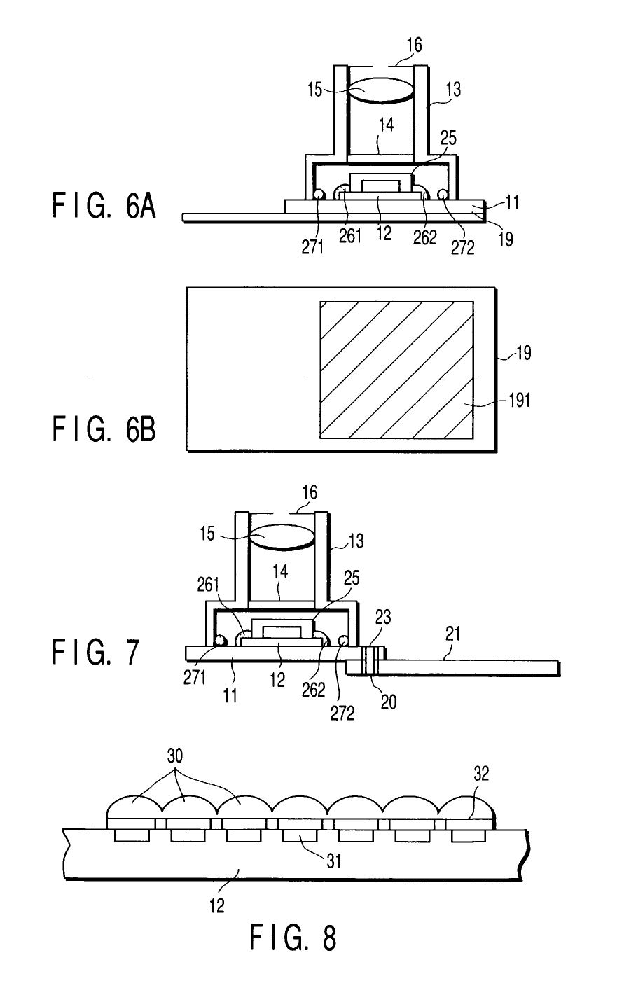

FIG. 6A and FIG. 6B are a cross-sectional view and a rear view showing a schematic structure of a small image pickup module according to a fifth embodiment of the present invention.

Namely, as shown in FIGS. 6A and 6B, the small image pickup module according to the fifth embodiment of the present invention comprises, as the basic structure: the substrate 11 made from a nonmetal including a ceramic or the like; the semiconductor device chip 12 for image pickup including a two-dimensional C-MOS image sensor or the like which is mounted on the nonmetal substrate 11; the lens-barrel body 13 which is attached as a reference to the nonmetal substrate 11 so as to cover the semiconductor device chip 12 for image pickup; and the infrared light (IR) blocking filter 14, the lens 15, and the diaphragm 16 which are respectively mounted on the lens-barrel body 13, as shown in FIG. 1.

In the basic structure of the small image pickup module structured in this way, the small image pickup module according to the fifth embodiment of the present invention is characterized by further comprising: a transparent member 25 which is provided between the nonmetal substrate 11 and the lens-barrel body 13 so as to isolate and protect a surface portion of the semiconductor device chip 12 for image pickup; and potting materials 261, 262 provided so as to cover the wire bonding or the like to an electrode lead at the peripheral portion of the semiconductor device chip 12 for image pickup and so as to simultaneously adhere the peripheral portion of the transparent portion 25 while avoiding a sensor portion of the semiconductor device chip, and characterized in that a flexible substrate 19 for external connection is mounted on the substrate 11, and a light-blocking pattern 191 formed by adhesion of a conductive material (etching), silkscreen printing or the like is formed on the flexible substrate 19 in order to block the light from the direction of the bottom portion of the substrate 11.

In the small image pickup module according to the fifth embodiment of the present invention structured as described above, a package in which a two-dimensional sensor according to prior art is independently housed can be omitted. A reduction in cost and an improvement in mounting performance can be attempted while improving the optical performance.

Namely, in the small image pickup module according to the fifth embodiment of the present invention, the transparent member 25 is provided so as to isolate and protect the surface portion of the semiconductor device chip 12 for image pickup. Further the sensor portion and the wire bonding portion are completely shielded from outside air while being Chip-On-Board (COB) mounted by the potting materials 261, 262 provided so as to cover the wire bonding to an electrode lead at the peripheral portion of the semiconductor device chip 12 for image pickup and so as to simultaneously adhere the transparent portion 25. Therefore, it is possible to completely prevent the sensor portion and the wire bonding portion from being damaged or a silicon surface of the sensor portion from oxidizing at the time of mounting and outer mounting assembly, and the wire bonding portion can be completely covered. Accordingly, handling in the same way as a COB mounted general IC is possible, and it is possible to reduce the size and reduce costs.

Further, the transparent member 25 is disposed so as to be isolated from the surface of the sensor, and thereby effects of the microlens at the surface of the sensor do not deteriorate and it is possible to reduce the size.

Namely, as shown in FIG. 8, when microlenses 30 are respectively mounted via color filters 32 with respect to the front surfaces of respective image pickup devices 31 at the semiconductor device chip 12 for image pickup mounted on the nonmetal substrate 11, the transparent member 25 is disposed so as to be isolated from the surface of the sensor, and thereby effects of the respective microlenses 30 at the surface of the sensor do not deteriorate, and it is possible to reduce the size.

In addition, in the two-dimensional sensor in accordance with prior art, the substrate for mounting a sensor must be a material which is expensive and has a light-blocking ability in order to provide the substrate itself with a light-blocking ability. However, in the small image pickup module according to the fifth embodiment of the present invention, as the material of the substrate 11, even a flexible substrate which does not have a light-blocking ability in particular can be used as is, and it can be inexpensive.

(Sixth Embodiment)

FIG. 7 is a cross-sectional view showing a schematic structure of a small image pickup module according to a sixth embodiment of the present invention.

Namely, as shown in FIG. 7, the small image pickup module according to the sixth embodiment of the present invention comprises, as the basic structure: the substrate 11 made from a nonmetal including a ceramic or the like; the semiconductor device chip 12 for image pickup including a two-dimensional C-MOS image sensor or the like which is mounted on the nonmetal substrate 11; the lens-barrel body 13 which is attached as a reference to the nonmetal substrate 11 so as to cover the semiconductor device chip 12 for image pickup; and the infrared light (IR) blocking filter 14, the lens 15, and the diaphragm 16 which are respectively mounted on the lens-barrel body 13, as shown in FIG. 1.

In the basic structure of the small image pickup module structured in this way, the small image pickup module according to the sixth embodiment of the present invention is characterized by further comprising: a transparent member 25 which is provided between the nonmetal substrate 11 and the lens-barrel body 13 so as to isolate and protect a surface portion of the semiconductor device chip 12 for image pickup; and potting materials 261, 262 provided so as to cover the wire bonding or the like to an electrode lead at the peripheral portion of the semiconductor device chip 12 for image pickup and so as to simultaneously adhere the peripheral portion of the transparent portion 25 while avoiding a sensor portion of the semiconductor device chip, and characterized in that a land-and-through-hole portion 20 for external connection is provided at the substrate 11, and electric connection and mechanical holding of the substrate 11 and another substrate 21 are made possible due to the other substrate 21 being soldered or engaged by a metal pin 23 at the land-and-through-hole portion 20.

In the small image pickup module according to the sixth embodiment of the present invention structured as described above, a package in which a two-dimensional sensor according to prior art is independently housed can be omitted. A reduction in cost and an improvement in mounting performance can be attempted while improving the optical performance.

Namely, in the small image pickup module according to the sixth embodiment of the present invention, the transparent member 25 is provided so as to isolate and protect the surface portion of the semiconductor device chip 12 for image pickup. Further the sensor portion and the wire bonding portion are completely shielded from outside air while being Chip-On-Board (COB) mounted by the potting materials 261, 262 provided so as to cover the wire bonding to an electrode lead at the peripheral portion of the semiconductor device chip 12 for image pickup and so as to simultaneously adhere the transparent portion 25. Therefore, it is possible to completely prevent the sensor portion and the wire bonding portion from being damaged or a silicon surface of the sensor portion from oxidizing at the time of mounting and outer mounting assembly, and the wire bonding portion can be completely covered. Accordingly, handling in the same way as a COB mounted general IC is possible, and it is possible to reduce the size and reduce costs.

Further, the transparent member 25 is disposed so as to be isolated from the surface of the sensor, and thereby effects of the microlens at the surface of the sensor do not deteriorate and it is possible to reduce the size.

Namely, as shown in FIG. 8, when microlenses 30 are respectively mounted via color filters 32 with respect to the front surfaces of respective image pickup devices 31 at the semiconductor device chip 12 for image pickup mounted on the nonmetal substrate 11, the transparent member 25 is disposed so as to be isolated from the surface of the sensor, and thereby effects of the respective microlenses 30 at the surface of the sensor do not deteriorate, and it is possible to reduce the size.

In addition, in the two-dimensional sensor in accordance with prior art, as the means for transmitting signals from the substrate for mounting a sensor to another substrate, connecting by cables, connectors, and the flexible substrate, or the like, is carried out via a third transmitting material with respect to another substrate. Therefore, this is a hindrance to prevention of noise generation and a reduction in costs. However, in the small image pickup module according to the sixth embodiment of the present invention, since the substrate 11 for mounting a sensor can be directly connected with the other substrate 21 at the through-hole portion 20, it is possible to reduce size, reduce costs, and prevent noise generation. Since the through-hole portion 20 is substantially light-blocked by soldering or the metal pin 23, it is possible to block the transmitted light by the through hole.

Further, in accordance with the present invention recited in claim 1 described later, the transparent member 25 is provided so as to isolate and protect the surface portion of the semiconductor device chip 12 for image pickup, and the sensor portion and the wire bonding portion are completely shielded from outside air while being Chip-On-Board (COB) mounted by the potting materials 261, 262 provided so as to cover a wire bonding portion or the like to an electrode lead at the peripheral portion of the semiconductor device chip 12 for image pickup and so as to simultaneously adhere the peripheral portion of the transparent portion 25. Therefore, it is possible to completely prevent the sensor portion and the wire bonding portion from being damaged or a silicon surface of the sensor portion from oxidizing at the time of mounting and outer mounting assembly, and the wire bonding portion also can be completely covered. Accordingly, handling in the same way as a COB mounted general IC is possible, and it is possible to reduce size and costs. In a case where a microlens is mounted on the semiconductor device chip 12 for image pickup, since the transparent member 25 is disposed so as to be isolated from the surface of the sensor, effects of the microlens at the surface of the sensor do not deteriorate, and it is possible to reduce the size.

Further, in accordance with the present invention recited in claim 2 described later, the transparent member 25 is provided so as to isolate and protect the surface portion of the semiconductor device chip 12 for image pickup, and the sensor portion and the wire bonding portion are completely shielded from outside air while being Chip-On-Board (COB) mounted by the potting materials 261, 262 provided so as to cover a wire bonding portion or the like to an electrode lead at the peripheral portion of the semiconductor device chip 12 for image pickup and so as to simultaneously adhere the peripheral portion of the transparent portion 25. Therefore, it is possible to completely prevent the sensor portion and the wire bonding portion from being damaged or a silicon surface of the sensor portion from oxidizing at the time of mounting and outer mounting assembly, and the wire bonding portion also can be completely covered. Accordingly, handling in the same way as a COB mounted general IC is possible, and it is possible to reduce size and costs. In a case where a microlens is mounted on the semiconductor device chip 12 for image pickup, since the transparent member 25 is disposed so as to be isolated from the surface of the sensor, effects of the microlens at the surface of the sensor do not deteriorate, and it is possible to reduce the size. Further, the potting materials 271, 272 to be used for Chip-On-Board (COB) mounting are used as the adhesive adhering the lens-barrel body 13 to the nonmetal substrate 11. Therefore, there is no problem such as the generation of rust or the like with respect to the sensor at the interior, and it is possible to contribute to an improvement in durability and assembly working performance.

Further, in accordance with the present invention recited in claim 3 described later, the transparent member 25 is provided so as to isolate and protect the surface portion of the semiconductor device chip 12 for image pickup, and the sensor portion and the wire bonding portion are completely shielded from outside air while being Chip-On-Board (COB) mounted by the potting materials 261, 262 provided so as to cover a wire bonding portion or the like to an electrode lead at the peripheral portion of the semiconductor device chip 12 for image pickup and so as to simultaneously adhere the peripheral portion of the transparent portion 25. Therefore, it is possible to completely prevent the sensor portion and the wire bonding portion from being damaged or a silicon surface of the sensor portion from oxidizing at the time of mounting and outer mounting assembly, and the wire bonding portion also can be completely covered. Accordingly, handling in the same way as a COB mounted general IC is possible, and it is possible to reduce size and costs. In a case where a microlens is mounted on the semiconductor device chip 12 for image pickup, since the transparent member 25 is disposed so as to be isolated from the surface of the sensor, effects of the microlens at the surface of the sensor do not deteriorate, and it is possible to reduce the size. Further, as a mounting structure for mounting the lens-barrel body 13 on the substrate 11, projections 121, 122 for positioning are provided at the bottom portion of the lens-barrel body 13 and fitting holes 111, 112, in which the projections 121, 122 for positioning provided at the bottom portion of the lens-barrel body are fitted, are provided at opposing positions on the nonmetal substrate 11. Therefore, the nonmetal substrate 11 may be plate-shaped as is, and thereby it is extremely inexpensive and assembly also is easy.

Further, in accordance with the present invention recited in claim 4 described later, the transparent member 25 is provided so as to isolate and protect the surface portion of the semiconductor device chip 12 for image pickup, and the sensor portion and the wire bonding portion are completely shielded from outside air while being Chip-On-Board (COB) mounted by the potting materials 261, 262 provided so as to cover a wire bonding portion or the like to an electrode lead at the peripheral portion of the semiconductor device chip 12 for image pickup and so as to simultaneously adhere the peripheral portion of the transparent portion 25. Therefore, it is possible to completely prevent the sensor portion and the wire bonding portion from being damaged or a silicon surface of the sensor portion from oxidizing at the time of mounting and outer mounting assembly, and the wire bonding portion also can be completely covered. Accordingly, handling in the same way as a COB mounted general IC is possible, and it is possible to reduce size and costs. In a case where a microlens is mounted on the semiconductor device chip 12 for image pickup, since the transparent member 25 is disposed so as to be isolated from the surface of the sensor, effects of the microlens at the surface of the sensor do not deteriorate, and it is possible to reduce the size. Further, the bare chips 18 of various ICs are mounted on the outer side portion or the like of the lens-barrel body 13 on the substrate 11, and thereby all of the deficiencies such as hindering prevention of noise generation and a reduction in costs or the like can be solved.

Further, in accordance with the present invention recited in claim 5 described later, the transparent member 25 is provided so as to isolate and protect the surface portion of the semiconductor device chip 12 for image pickup, and the sensor portion and the wire bonding portion are completely shielded from outside air while being Chip-On-Board (COB) mounted by the potting materials 261, 262 provided so as to cover a wire bonding portion or the like to an electrode lead at the peripheral portion of the semiconductor device chip 12 for image pickup and so as to simultaneously adhere the peripheral portion of the transparent portion 25. Therefore, it is possible to completely prevent the sensor portion and the wire bonding portion from being damaged or a silicon surface of the sensor portion from oxidizing at the time of mounting and outer mounting assembly, and the wire bonding portion also can be completely covered. Accordingly, handling in the same way as a COB mounted general IC is possible, and it is possible to reduce size and costs. In a case where a microlens is mounted on the semiconductor device chip 12 for image pickup, since the transparent member 25 is disposed so as to be isolated from the surface of the sensor, effects of the microlens at the surface of the sensor do not deteriorate, and it is possible to reduce the size. Further, the flexible substrate 19 for external connection is mounted on the substrate 11, and a light-blocking pattern 191 which blocks light from the direction of the bottom portion of the substrate 11 is formed on the flexible substrate 19. Thus, as the material of the substrate 11, even a flexible substrate which does not have a light-blocking ability in particular can be used as is, and it can be inexpensive.

Further, in accordance with the present invention recited in claim 6 described later, the transparent member 25 is provided so as to isolate and protect the surface portion of the semiconductor device chip 12 for image pickup, and the sensor portion and the wire bonding portion are completely shielded from outside air while being Chip-On-Board (COB) mounted by the potting materials 261, 262 provided so as to cover a wire bonding portion or the like to an electrode lead at the peripheral portion of the semiconductor device chip 12 for image pickup and so as to simultaneously adhere the peripheral portion of the transparent portion 25. Therefore, it is possible to completely prevent the sensor portion and the wire bonding portion from being damaged or a silicon surface of the sensor portion from oxidizing at the time of mounting and outer mounting assembly, and the wire bonding portion also can be completely covered. Accordingly, handling in the same way as a COB mounted general IC is possible, and it is possible to reduce size and costs. In a case where a microlens is mounted on the semiconductor device chip 12 for image pickup, since the transparent member 25 is disposed so as to be isolated from the surface of the sensor, effects of the microlens at the surface of the sensor do not deteriorate, and it is possible to reduce the size. Further, the land-and-through-hole portion 20 for external connection is provided at the substrate 11, and another substrate 21 is engaged at the land-and-through-hole portion 20. Therefore, the substrate 11 for mounting a sensor is directly connected with the another substrate 21 at the through-hole portion 20, and thereby it is possible to reduce size, reduce costs, and prevent noise generation.

Further, in accordance with the present invention, it is possible to provide a small image pickup module in which, in a structure in which a semiconductor device chip for image pickup, including a two-dimensional C-MOS image sensor or the like, is mounted on a substrate made from a nonmetal including a ceramic or the like, and a lens-barrel is mounted so as to cover it, due to the mounting structure being variously improved, the assembly work is easy and a reduction in costs is possible, and further, a microlens for making an aperture large and increasing the efficiency of the incident light can be disposed on a surface of a light receiving portion of the semiconductor device chip for image pickup.

Note that, as described above, in the prior art in accordance with Japanese Patent No. 2559986, it is mounted on the substrate by utilizing a spring effect using the side wall of an enclosure. Therefore, there is the problem that joggling based on the creep phenomenon over time occurs. However, in the present invention recited in claim 1 described later, a potting material to be used for Chip-On-Board (COB) mounting is used as the adhesive adhering the lens-barrel body to the substrate in order to basically prevent load from being applied to the side wall. Therefore, it is possible to overcome the problem of joggling based on the creep phenomenon over time occurring.

Further, as described above, in the prior art in accordance with Jpn. Pat. Appin. KOKAI Publication No. 9-232548, because all are structured from a single member, there are the problems that the shape and the structure are complicated, the productivity is poor, and the manufacturing costs increase. However, in the present invention recited in claims 1 to 12 described later, all are not basically structured from a single member. Accordingly, the shapes and the structures of the respective members are simple, the productivity is good, and a reduction in manufacturing costs can be attempted.

Further, as described above, in the prior art in accordance with Jpn. Pat. Appln. KOKOKU Publication No. 8-28435, since there is a structure in which a metal can and a lens molten glass are adhered, there is the need to consider the wetting characteristic of the molten glass. However, in the present invention recited in claims 1 to 6 described later, by basically using a lens which has already been molded, there is no need to consider the wetting characteristic of a molten glass.

Further, as described above, in the prior art in accordance with Jpn. Pat. Appln. KOKAI Publication No. 10-41492, since it is a structure in which a lens cap and a pedestal are positioned and fixed by a guiding pin, the lens cap and the guiding pin are necessary. Therefore, there are the problems that the structure is complicated, the productivity is poor, and the manufacturing costs increase. However, in the present invention recited in claims 1 to 6 described later, the lens cap is basically not necessary, and the guiding pin is not always necessary.

Accordingly, as described above, according to the present invention, in a structure in which a semiconductor device chip for image pickup, including a two-dimensional C-MOS image sensor or the like, is mounted on a substrate made from a nonmetal including a ceramic or the like, and a lens-barrel is mounted so as to cover the semiconductor device chip for image pickup, the mounting structure is variously improved. Accordingly, it is possible to provide a small image pickup module in which the assembly work is easy and a reduction in costs is possible.

Moreover, according to the present invention, there can be provided a small image pickup module such that, in a structure in which a semiconductor device chip for image pickup, including a two-dimensional C-MOS image sensor or the like, is mounted on a substrate made from a nonmetal including a ceramic or the like, and a lens-barrel is mounted so as to cover the semiconductor device chip for image pickup, the mounting structure thereof is variously improved. Therefore, the assembly work is easy and a reduction in costs is possible. Further, it is possible to dispose a microlens for making an aperture large and increasing the efficiency of the incident light, on a surface of a light receiving portion of the semiconductor device chip for image pickup.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A small image pickup module comprising:
a substrate made from a nonmetal including a ceramic or the like;
a semiconductor device chip for image pickup including a two-dimensional C-MOS image sensor or the like which is mounted on the substrate;
a lens-barrel body which is attached to the substrate so as to enclose the semiconductor device chip for image pickup therein;
an infrared light blocking filter, a lens, and a diaphragm which are respectively mounted on the lens-barrel body;
a transparent member which is provided between the substrate and the lens-barrel body so as to isolate and protect a surface portion of the semiconductor device chip for image pickup; and
a potting material which is provided so as to cover an electrode lead or the like at a peripheral portion of the semiconductor device chip for image pickup and so as to simultaneously adhere a peripheral portion of the transparent member.

2. A small image pickup module according to claim 1, wherein a potting material to be used for COB (Chip On Board) mounting is used as an adhesive adhering the lens-barrel body to the substrate.

3. A small image pickup module according to claim 1, wherein, as a mounting structure which mounts the lens-barrel body on the substrate, projections for positioning are provided at a bottom portion of the lens-barrel body, and fitting holes, in which the projections for positioning provided at the bottom portion of the lens-barrel body are fitted, are provided at opposing positions on the substrate.

4. A small image pickup module according to claim 1, wherein bare chips of various ICs are mounted on the substrate.

5. A small image pickup module according to claim 1, wherein a flexible substrate for external connection is mounted on the substrate, and a light-blocking pattern which blocks light from a direction of a bottom portion of the substrate is formed on the flexible substrate.

6. A small image pickup module according to claim 1, wherein a land-and-through-hole portion for external connection is provided at the substrate, and electric connection and mechanical holding with another substrate are made possible due to another substrate being engaged at the land-and-through-hole portion.

7. A small image pickup module according to any one of claims 1 to 6, wherein a microlens is provided at a front surface of the semiconductor device chip for image pickup.
